(19) United States
(12) Patent Application Publication
(10) Pub. No.: US 2005/0154618 A1
(43) Pub. Date: Jul. 14, 2005

(54) Environmentally hazardous substance insurance system, computer program product, and business method using insurance certificate regarding environmentally hazardous substance and results of analysis by third party

(75) Inventor: Fusaji Kita, Osaka (JP)

Correspondence Address: OSHA LIANG L.L.P., 1221 MCKINNEY STREET, SUITE 2800, HOUSTON, TX, 77010, US

(73) Assignee: Hitachi Maxell, Ltd., Osaka (JP)

(21) Appl. No.: 11/021,532

(22) Filed: Dec. 22, 2004

(30) Foreign Application Priority Data
Dec. 26, 2003 (JP) JP2003-435124

(51) Int. Cl. G06F 17/60

(52) U.S. Cl. 705/4

(57) ABSTRACT

A system and a computer program product calculates an insurance premium for environmentally hazardous substance insurance to compensate for damages in the case in which an environmentally hazardous substance is included, by accident, in a product of the insured party. The environmentally hazardous substance insurance system includes, as contracted party information relating to the insured party, at least information specifying the environmentally hazardous substance that is to be insured against, an input output process portion to input information relating to the results of analysis of the product of the contracted party; a contracted party information memory portion for at least temporarily recording the contracted party information and an insurance premium calculation portion to calculate the insurance premium based on the contracted party information stored in the contracted party information memory portion.

### FIELD OF THE INVENTION

The present invention relates to environmentally hazardous substance insurance, and particularly relates to systems for calculating an insurance premium that an insured party should pay to an insurer, and to computer program products for realizing these systems. The present invention also relates to an insurance system and a business method using an insurance certificate regarding an environmentally hazardous substance and results of analysis by a third party.

### DESCRIPTION OF THE RELATED ART

In February 2003, the RoHS Directive came into effect, meaning that lead, mercury, cadmium, chromium VI, polybrominated biphenyl (PBB) and polybrominated diphenyl ether (PBDE) may no longer be used in, for example, electronic devices, sold from July 2006. Furthermore, in addition to this, laws and regulations relating to various environmentally hazardous substances (that is to say, substances that affect humans and the environment, and that should be regulated by law) exist, or are heading for approval throughout the world. Thus, in addition to not to using environmentally hazardous substances intentionally, businesses must also now take precautions with respect to the unintentional inclusion of environmentally hazardous substances in products. Moreover, there is an increase in cases in which businesses are requested by the customers of their products to guarantee that various environmentally hazardous substances are not contained within those products, and to guarantee compensation of damages in the case of an accident.

Thus, in addition to planning such that environmental related substances are not used, manufacturers must also take precautions with respect to the materials and products that they use, even with respect to the occurrence of non-intentional or accidental contamination by environmentally hazardous substances. For this, it is also necessary to get the assistance of material suppliers, to tighten the management of environmentally hazardous substances, and also to confirm this by regular analysis. However, analysis is always just the inspection of samples, and it is not possible to analyze every item and every portion. Thus, it is not possible to state that the risk of inclusion of environmentally hazardous substances is zero. Furthermore, it is necessary for businesses to make every possible effort to gather information so as to diligently conform to laws, for example even in regions of specific countries in which strict laws regulating those substances have been passed. It may be very difficult for small to medium sized businesses to manage these on their own.

On the other hand, in the rare event that an accident occurs, there is the possibility of enormous damages, and for manufacturers and vendors, the alleviation of risk is a very important issue. If an accident occurs, there is the possibility of bearing a debt that is impossible for a small to medium size business to repay, and it is also conceivable that customers may be inconvenienced by the company not even being able to pay them compensation. Although it would be sufficient for an insurance or warrantee system to be set up against such risks, at the present time, there is no such insurance relating to environmentally hazardous substances. While product liability insurance may apply in cases of product liability accidents, there is the problem that sufficient coverage may not be provided for incidents with respect to the inclusion of environmentally hazardous substances.

Although no conventional examples could be found of an insurance regarding an environmentally hazardous substance, for an example of a related insurance there is the example described in Japanese Patent 3226468 (claim 7, for example), in which damage by a typhoon is evaluated and the insured amount calculated from meteorological information.

As noted above, conventionally, there have been no insurance systems for insuring against environmentally hazardous substances, and manufacturers have had to bear the risk of events such as accidents involving unintentional contamination with environmentally hazardous substances, with those risks still remaining after taking countermeasures for contamination prevention.

The present invention provides a computer system and a computer program product for calculating an appropriate insurance premium that the insured party should pay to the insurer, in order to realize environmentally hazardous substance insurance to insure against accidents involving environmentally hazardous substances.

The present invention also provides an insurance system and a business method using an insurance certificate regarding an environmentally hazardous substance and results of analysis by a third party.

### SUMMARY OF THE INVENTION

In one or more embodiments, the environmentally hazardous substance insurance system according to the present invention is a computer system to calculate an insurance premium of an environmentally hazardous substance insurance to compensate for damages if an environmentally hazardous substance is included in a product that is to be insured of an insured party due to accident, the environmentally hazardous substance insurance system including an input portion for inputting at least information specifying the environmentally hazardous substance that is to be insured and information relating to a result of analysis of the product of the insured party, as contracted party information relating to the insured party, a contracted party information memory portion for at least temporarily recording the contracted party information, and an insurance premium calculation portion to calculate the insurance premium based on the contracted party information stored in the contracted party information memory portion.

In one or more embodiments, the computer program according to the present invention is a computer program to calculate an insurance premium of an environmentally hazardous substance insurance to compensate for damages if an environmentally hazardous substance is included in a product that is to be insured of an insured party due to accident, wherein the computer program includes commands to let a computer execute a process of inputting at least information specifying an environmental related substance to be insured and information relating to results of analysis of a product of the contracted party, as contracted party information relating to the insured party, a process of at least temporarily recording the contracted party information, to a contracted party information memory portion, and a process of calculating the insurance premium based on the contracted party information recorded in the contracted party information memory portion.

According to embodiments of the present invention, in an arrangement of environmentally hazardous substance insurance in which, if an environmentally hazardous substance, which despite not being used by design, contaminates by incident or accident a product of an insured party, then an insurer compensates for the damage, it is possible to calculate an appropriate insurance premium based on at least information specifying the environmentally hazardous substance to be insured against, and information relating to the results of analysis of the product of the contracted party. Thus, it is possible for the insured party to manufacture and sell products, in which there is a possibility of contamination by environmentally hazardous substances even if all precautions are taken, at a lower risk, and in the off chance that an accident occurs, to receive a large compensation. On the other hand, for the insurer, by specifying the environmentally hazardous substance to be insured against, and setting the insurance premium based on results of analysis of the product of the insured party, the compensation loss risk can be reduced.

Furthermore, according to the present invention, higher reliability can be obtained from customers by an insurance system and a business method using an insurance certificate regarding an environmentally hazardous substance and results of analysis by a third party

### BRIEF DESCRIPTION OF THE DRAWINGS

FIG. 1 is an explanatory diagram showing an example of insurance certificates concluded between relevant parties in the insurance system according to an embodiment of the present invention.

FIG. 2 is an explanatory diagram showing transactions between the relevant parties in the insurance system according to an embodiment of the present invention.

FIG. 3 is a block diagram showing an example of a structural overview in a case in which the insurance system according to an embodiment of the present invention is organized as an online system.

FIG. 4 is an explanatory diagram showing an example of contracted party information used in the insurance system according to an embodiment of the present invention.

FIG. 5 is an explanatory diagram showing an example of results of analysis at the time of concluding an insurance contract in the insurance system according to an embodiment of the present invention.

FIG. 6 is an explanatory diagram showing an example of the results of analysis at a time after concluding the insurance contract in the insurance system according to the present invention.

FIG. 7 is an explanatory diagram showing an example of a certificate of the results of analysis, based on an example of results of analysis after a certain period has passed after concluding the insurance contract.

### DETAILED DESCRIPTION OF THE INVENTION

In the present invention, “environmentally hazardous substances” are substances having an adverse effect on the environment that should be regulated by laws, such as the RoHS Directive. It is usually the case that a plurality of substances is designated as environmentally hazardous substances (designated environmentally hazardous substances) that are to be insured against. “Not used by design” means that designated environmentally hazardous substances are not intentionally used.

In the environmentally hazardous substance insurance system or the computer program product according to the present invention, it is preferable to input in detail, for example, information on the insured product as contracted party information, however it is particularly preferable to have an embodiment in which information relating to variability of results of analysis of the environmentally hazardous substance carried out on a plurality of lots of the insured product is input by the input portion as information relating to the results of analysis of the product of the contracted party, and in which the insurance premium is calculated with consideration to this information.

A reason why this embodiment is preferable is given below. Most products are items that are either manufactured from natural substances (minerals such as oil and iron ore, lumber and air, for example) or are manufactured using materials extracted from natural substances. Products are made using materials manufactured in the same place and in a similar way, or the products are made after further processing. The variability of substances contained in products made in this way depends to a certain extent on the distribution of elements in the natural environment. Provided that it is not intentionally added, a substance that is originally scarce in the natural world should be able to be maintained at a low level. Furthermore, even if the raw material is extracted from ore or a mineral vein in which the probability of an element being present is above a certain level, it still exists with a constant level of variability. The inventors of the present invention believe that by using the theory which gives the distribution of such substances within the natural environment, from the analytical data of environmentally hazardous substances of a plurality of lots it is possible to predict the probability of an environmentally hazardous substance being equal to or more than a pre-set value. Based on this theory as noted above, by calculating the insurance premium based on the variability of analytical data of the environmentally hazardous substance in a plurality of lots, it is possible to set an insurance premium that is compatible with the loss compensation risk.

If the insured party does not use the designated environmentally hazardous substances in the process of manufacturing the product, then the present embodiment is preferable because the variability in distribution of the environmentally hazardous substance in the natural environment is further reflected in the quantity of environmentally hazardous substance included in the product. Consequently, it is preferable that the insurer gets the insured party to declare that they do not use the designated environmentally hazardous substance in their manufacturing process, and it is more preferable that they get the insured party to sign a certificate guaranteeing non-use of the substance.

According to the above-noted embodiment, the insurer can calculate the loss compensation risk from the numerical level of the data and the degree of variability, and in addition to being able to suppress the probability of the occurrence of an accident involving environmentally hazardous substances in the product, it is possible to substantially decrease the insurance premium rate by an amount commensurate with the reduction of the risk. It should be noted that as for the products to be analyzed, the insured party provides the insured product to the insurer or to the party to whom the analysis is commissioned. The cost of the analysis can be charged separate to the insurance premium, it can be selected as an option, or it can be included in the insurance premium. Although this leads to an increase in costs, because analysis is carried out on the product of a multitude of insured parties, it is possible to suppress the total cost of analysis to less than that in which analysis is self-managed for the contracted party.

Furthermore, in the environmentally hazardous substance insurance system or the computer program product according to the present invention, it is preferable that an embodiment is taken in which one, or two or more pieces of information selected from information on trust of the insured party, product sales information, manufacturing country information, sales country information, maximum compensation amount, product risk information, number of types of environmentally hazardous substance that are insured against, degree of risk of the environmentally hazardous substance to be insured against and frequency of analysis of the insured product, are further input as the contracted party information.

By these factors, because the probability of occurrence of an accident involving the environmentally hazardous substance fluctuates, when the insurance contract is concluded when information is scarce it is impossible for the insurer to avoid setting a high insurance premium rate, and the insurance premium becomes expensive for the party applying for the insurance. Consequently, it is preferable to base the insurance premium calculation on at least two or more, preferably on four or more, and most preferably on six or more of the above-noted factors. Thus, by inputting information in greater detail relating to the insured party itself and to the products and the like of the insured party, the insurance premium can be more affordable because the loss compensation risk can be estimated more accurately.

Furthermore, in the above-noted preferred embodiment of the environment related insurance system or computer program product according to the present invention, it is further preferable that if there is a difference with the pre-renewal value that is equal to or greater than a standard difference as a result of a renewal of information included in the contracted party information from among: product risk information, manufacturing country information, sales country information, the number of types of environmentally hazardous substance that are to be insured against and the degree of risk of the environmentally hazardous substance that is to be insured against, then the insurance premium calculation portion recalculates the insurance premium based on the contracted party information after the renewal.

By renewing information that is the foundation of the insurance premium calculation, and by re-calculating the insurance premium rate, if a variation that is equal to or greater than a standard amount occurs, then it is possible to swiftly handle changes in the situation of the insured party or social conditions.

Furthermore, the insurer can confirm that the insured party is not intentionally using designated environmental related substances based on the results of the analysis of the insured product, after which the insurer can decide whether or not to accept the risk, and it is further preferable that, if the risk is accepted, then the insurance premium rate is determined based on the results of the analysis. In particular in the environmentally hazardous substance insurance system and the computer program product according to the present invention, in order to ensure the objectivity of the results of the analysis, it is preferable that an embodiment is taken such that information relating to whether or not a party other than the insured party performs analysis relating to environmental related substances of the insured product is further input as contracted party information.

It is preferable that the analysis relating to the environmentally hazardous substance in the insured product is performed by a third party, who is not one of the relevant parties to the insurance contract. For example, it may be a public analytical organization, or it may be an analytical company. The insurer may also carry out the analysis directly, though it is preferable that the insurer contracts it out to a designated analytical organization. Most preferable is the case in which the insurer does not just directly analyze the product, or get a designated analytical organization to analyze the product at the time at which the insurance contract is concluded, but rather analyzes different lots of the product to ascertain the state of inclusion of the environmentally hazardous substance in the product over a plurality of analyses. This analysis is preferably performed at regular intervals after concluding the insurance contract. It is further preferable that such analysis is performed on each different lot. Thus, by regularly commissioning analysis by the insurer, or a third party, the occurrence of accidents involving environmentally hazardous substances can be suppressed, and the level of trust of the party who is applying for insurance is raised when doing business with their customers.

Next, a more specific embodiment of the present invention is explained in more detail with reference to the drawings.

In the environmentally hazardous substance insurance system according to the present embodiment, the insured party and the insurer conclude an insurance contract such that if, due to accident, designated environmentally hazardous substances are contained in the insured party's products, then the insurer will compensate for damages thus arising. Then, the insured party can present the insurance certificate to their customers. Thus, if designated environmentally hazardous substances are unintentionally included in products that the insured party manufactures and sells, then the insurer will compensate for damages incurred by the insured party's customers. It should be noted that “designated environmentally hazardous substances” means the environmentally hazardous substances that are the object of the insurance.

Furthermore, the environmentally hazardous substance insurance system according to the present embodiment analyses the insured party's products (the products to be insured) at the time of concluding the insurance contract, and at a predetermined time after that, and determines the insurance premium rate and the insurance premium in accordance with these results. In particular, it is preferable that a plurality of lots of the products to be insured are analyzed, and the variability of the analytical values of the designated environmentally hazardous substances between different lots are utilized to determine the insurance premium rate.

It should be noted that OO Electric Company, XX Electrical Parts Corporation, or any other names used in the description of the present embodiment below are purely fictional and do not represent actual companies or businesses.

In the present embodiment, OO Electric Company is a customer, and XX Electrical Parts Corporation is the manufacturer and vendor of a product V (the product to be insured) and is the party applying for insurance. Furthermore, AAA Insurance Company is the insurer, and commissions regular analysis of the product V to NN Analytical Company. The substances to be insured against are taken to be the six RoHS substances, that is, lead, cadmium, mercury, chromium VI (Cr6+), PBB and PBDE.

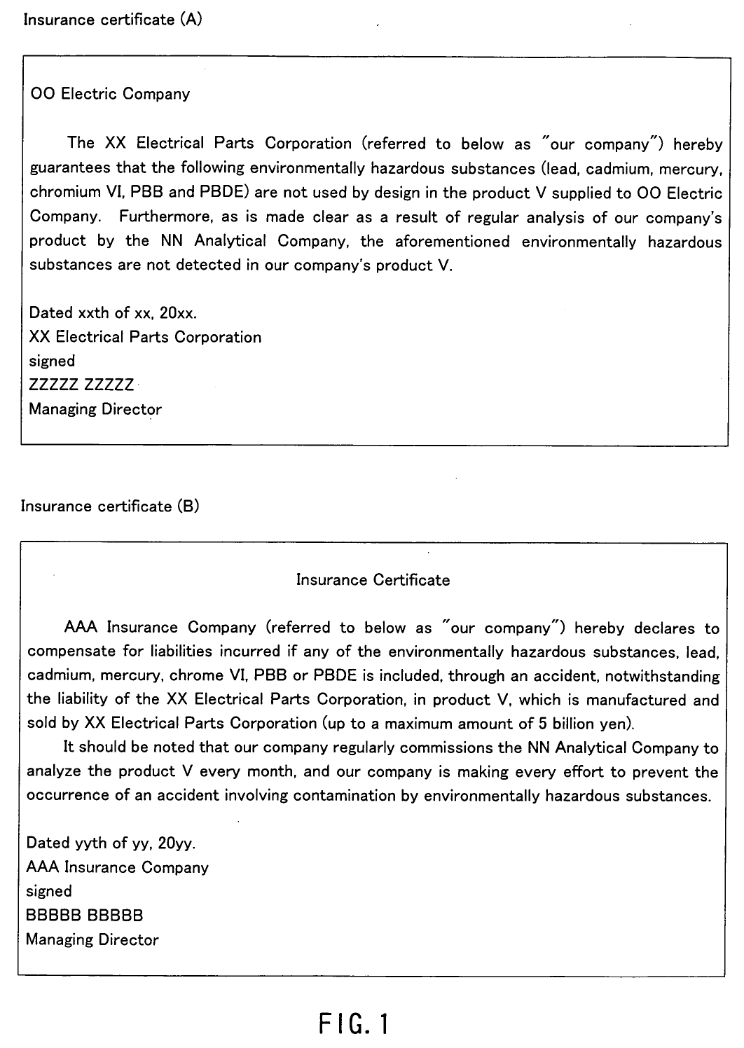

XX Electrical Parts Corporation provides both insurance certificates (A) and (B), for example as shown in FIG. 1 to OO Electric Company, which is its customer. The insurance certificate (A) is a document in which XX electric parts corporation guarantees to OO Electric Company that the product V does not contain environmentally hazardous substances by design. The insurance certificate (B) is a document showing that if, by accident, an environmentally hazardous substance is involved, then the AAA Insurance Company will compensate. The insurance certificate (B) is also a document showing that XX electric parts corporation has an auditing system in which AAA Insurance Company regularly lets NN Analytical Company analyze the product V. It should be noted that NN Analytical Company is a third party organization that is completely independent of both the XX electric parts corporation and the AAA Insurance Company. Thus, by adopting a system in which auditing is performed by a third party organization, it is possible to improve trustworthiness and gain the confidence of customers.

In order for the insured party to guarantee that “designated environmentally hazardous substances are not used by design”, it is preferable that the results of the analysis showing that the designated environmentally hazardous substances are at a non-harmful level, such as that the designated environmentally hazardous substances are not detected in the product by usual analytical means or that the amount of designated environmentally hazardous substances detected in the product is at a background or error level, are provided to the customer together with the insurance certificate (A).

Furthermore, if it is troublesome to change the insurance certificate (B) for each customer, then it is possible to make a guarantee with a standard form that includes general environmentally hazardous substances. In this case, it is preferable that the insured party provides this certificate to the customer, together with the insurance certificate (A) certifying that the product does not use designated environmentally hazardous substances by design. It is also preferable that all the environmentally hazardous substances designated by the customer are included in the insurance certificate (B). This is so as to prevent an uninsurable event if environmentally hazardous substances are unintentionally included.

Furthermore, it is preferable to add a service in which the results of analysis of the product commissioned to NN Analytical Company for analysis are provided in response to a request from the insured party. This is because if a customer of the insured party (in this example, OO Electric Company) causes an environmentally hazardous substance accident, it is a powerful piece of evidence for determining the presence or absence of responsibility. Furthermore, it is also preferable to regularly carry out environmentally hazardous substance analysis of the insured products, and to link this information to at least one of management of the insurance certificate (B), calculation of the insurance premium, an information providing service to the insured, warnings, and advice on handling such. As well as providing a more useful service, this also serves the purpose of preventing accidents involving environmentally hazardous substances, and suppressing damage.

Herein, it is assumed that an insured party that is a manufacturer or a vendor of a product can receive the results of analysis by a third party such as the NN Analytical Company. The manufacturer or the vendor can further obtain the reliability from a customer by presenting a certificate of the results of analysis by the third party together with one of the insurance certificates A and B to the customer, which is preferable as a business method. In this case, the certificate and the insurance certificate may not be submitted simultaneously. Even when the submission time of the certificate is shifted from that of the insurance certificate over a period from a time before the sale of the product to the customer to a time during which the product is being sold, the certificate and the insurance certificate may be considered to be submitted at a time when they are prepared. The results of analysis are desirably those of a plurality of lots of the product, more desirably at least 5 lots, and most desirably at least 10 lots. The number of lots is desirably large. However, even if the number is too large, the effect is hardly changed. Therefore, it is desirable that the number is limited to 100 or less. The number of material groups to be analyzed is desirably a plurality of kinds, more desirably at least 4 material groups, and most desirably at least 6 material groups. The number of material groups refers to the number of groups of materials such as 28 material groups of JEITA.

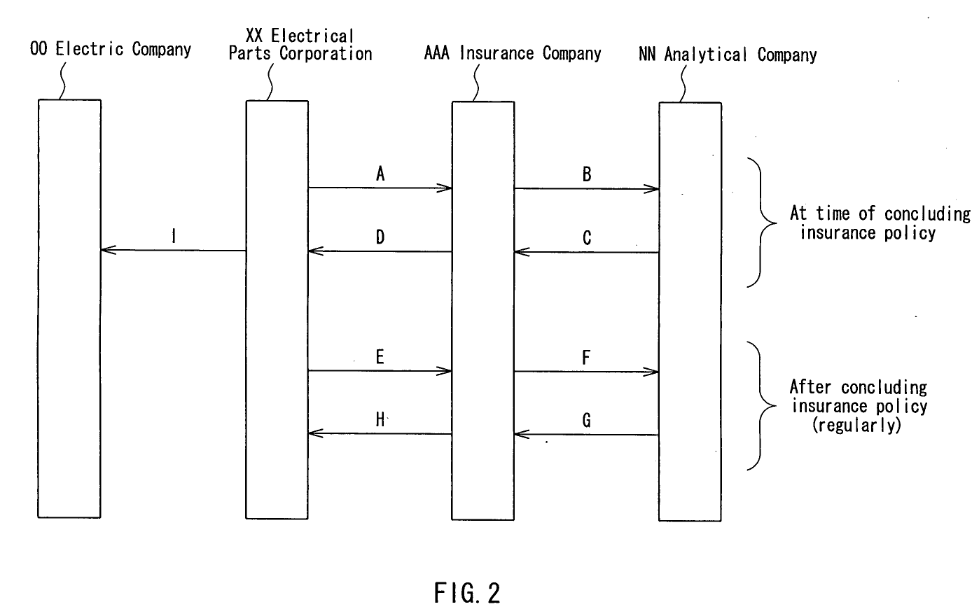

An example of exchanges between the party applying for insurance and the insurer, when the insurance certificate (B) is issued, is shown in FIG. 2.

First, the party applying for insurance (XX Electrical Parts Corporation) applies for insurance (transaction A in FIG. 2) to the insurer (AAA Insurance Company). At this time, XX Electrical Parts Corporation provides necessary information relating to the product to be insured (product V), and also provides a sample of the product to be insured, for analysis. This is because it is necessary for the AAA Insurance Company to commission the third party organization (NN Analytical Company) to analyze the product to be insured.

The AAA Insurance Company sends the sample of the product V provided by XX Electrical Parts Corporation to NN Analytical Company, and requests analysis for environmentally hazardous substances (transaction B). NN Analytical Company sends the analysis results report on the product to AAA Insurance Company (transaction C).

AAA Insurance Company determines whether to accept the insurance risk or not. If the risk is accepted, then an insurance rate appropriate to XX Electrical Parts Corporation is determined in accordance with the content of the analysis results report. If the risk is accepted, then documents such as an insurance contract and detailed instructions about the insurance are drawn up, and are sent to XX Electrical Parts Corporation (transaction D). At this time, AAA Insurance Company issues a certificate for XX Electrical Parts Corporation such as the insurance certificate (B) in FIG. 1.

By the transactions A to D noted above, an insurance contract is established between XX Electrical Parts Corporation and AAA Insurance Company. When the insurance contract is established, in addition to issuing the insurance certificate (A) in FIG. 1 to the customer (OO Electric Company), XX Electrical Parts Corporation forwards the above-noted insurance certificate (B) (transaction I). Thus, by attaching the insurance certificate (B), the confidence of the customer (OO Electric Company) in the XX Electrical Parts Corporation increases, and, for example, even if the XX electric parts corporation is a relatively small scale business, it becomes easier for them to establish business with customers.

After the insurance contract is concluded, XX Electrical Parts Corporation pays an insurance premium based on the predetermined insurance premium rate to the AAA Insurance Company (transaction E) before a predetermined monthly payment date. Furthermore, every month, the XX Electrical Parts Corporation provides AAA Insurance Company with samples of the product V for analysis. However, this is an example, and it is also possible to have payment on a yearly basis.

The AAA Insurance Company sends the samples for analysis provided by the XX Electrical Parts Corporation to the NN Analytical Company, and requests the regular analysis (transaction F). The NN Analytical Company sends the regular analysis results report of the sample to the AAA Insurance Company. The AAA Insurance Company investigates whether it is necessary to change the insurance premium rate in accordance with the results of the regular analysis results report from the NN Analytical Company. As a result, if the insurance premium rate is changed, the newly appropriate insurance premium rate is notified to the XX Electrical Parts Corporation (transaction H).

It should be noted that the present embodiment is just an example, and various alternatives are possible. For example, the form of the insurance certificate arranged between the relevant parties is not limited to the example shown in FIG. 1, and may take any form. Furthermore, in the foregoing description, an example was given in which the analysis is performed regularly every month to review the insurance premium rate, however the period of regular analysis and for reviewing the insurance premium rate is not limited to one month. For example the regular analysis may be carried out on every lot, and it may be carried out at a period that is shorter than one month or at a period that is longer. Furthermore, it is also possible that the period of regular analysis and the period of reviewing the insurance premium rate need not necessarily coincide. For example, it is possible to perform the regular analysis every month, and to perform the review of the insurance premium rate based on the results of the regular analysis over a longer period (for example 6 months or a year). Or, as will be explained later, it is possible to review the insurance premium rate when a change occurs in predetermined conditions relating to the insured party's situation or societal circumstances.

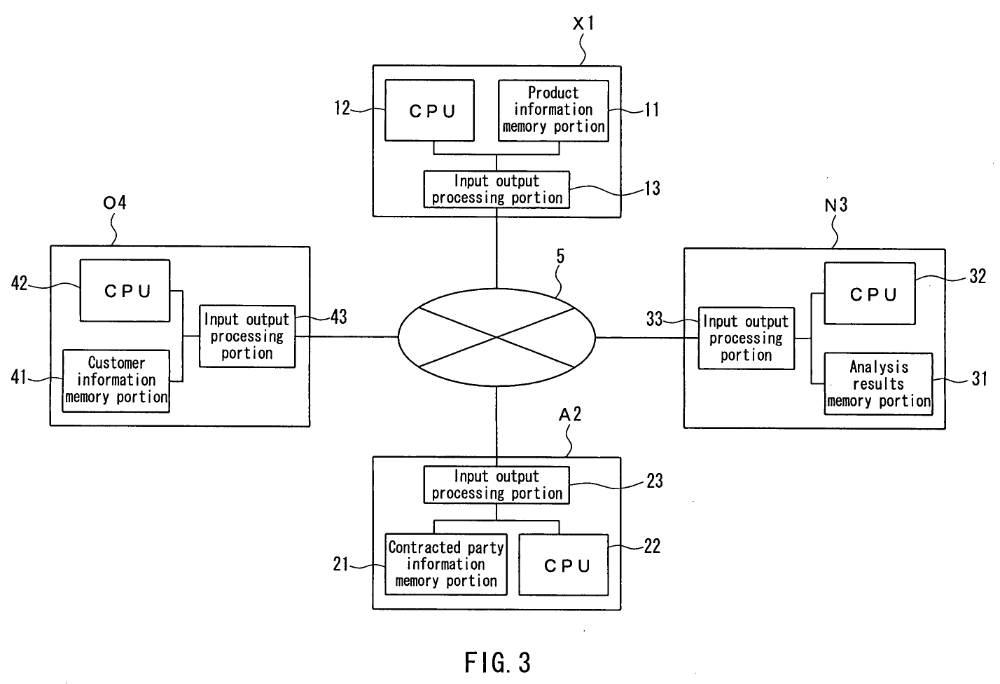

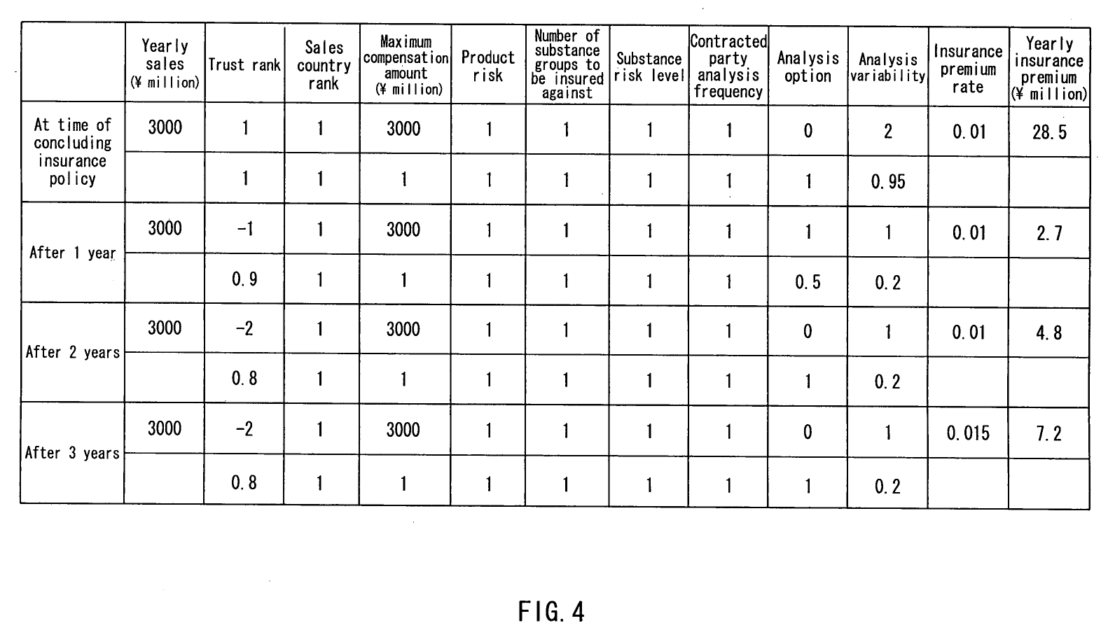

Here a structural outline and an example of the operation of the parts of the computer system for realizing the above-noted transactions A to I are illustrated with reference to FIG. 3 and FIG. 4.

As shown in FIG. 3, a computer system X1 of the XX Electrical Parts Corporation, a computer system A2 of the AAA Insurance Company, a computer system N3 of the NN Analytical Company and a computer system O4 of the OO Electric Company are connected via a network 5. The network 5 may be an open network such as the internet, or it may be constituted by dedicated wires installed between these businesses.

The transactions A to I of FIG. 2 are realized by the mutual exchange of necessary data by CPUs 12, 22, 32 and 42 included in the computer systems X1, A2, N3 and O4, via the network 5 and input output processing portions 13, 23, 33 and 43. Furthermore, data exchanged between the computer systems X1, A2, N3 and O4 are stored in a memory portion provided with each system (such as a product information memory portion 11, a contracted party information memory portion 21, an analysis results memory portion 31 and a customer information memory portion 41), and it can be extracted as necessary.

Thus, a method for reviewing the insurance premium rate is illustrated in detail, giving a specific example in relation to transactions G and H.

The AAA Insurance Company stores information (contracted party information) relating to XX Electrical Parts Corporation in the contracted party information memory portion 21 of the computer system A2. The contracted party information memory portion 21 that stores the contracted party information may be realized by a device such as a hard disk drive or optical disk drive provided in the computer system A2, or alternatively by a data server.

In the present embodiment, necessary data, such as the contracted party information is transmitted from the computer system XI of the XX Electrical Parts Corporation to the computer system A2 of the AAA Insurance Company. In this case, in the computer system XI, the information required by the input output processing portion 13 can be extracted from the product information memory portion 11, in which various information relating to the product of the XX Electrical Parts Corporation is stored, and the data transmitted to the computer system A2 via the network 5.

For the contracted party information, information in which the insured party designates the environmentally hazardous substances that are to be the object of the insurance, and information relating to the analysis results of the product of the insured party are used as the principal information, however alternatively, it is possible to use a variety of information. In the present embodiment, as shown in FIG. 4, information such as yearly sales relating to the insured product of the XX Electrical Parts Corporation, trust rank of the XX Electrical Parts Corporation, rank of the country of sale, maximum compensation amount, product risk, rank of the number of substance groups to be insured against, substance risk level, contracted party analysis frequency, analysis options and analysis variability may be used as the contracted party information relating to XX Electrical Parts Corporation. Furthermore, it is also possible to include items such as rank of the manufacturing country. It should be noted that FIG. 4 is a diagram showing an example of shifts in the contracted party information from the year in which the insurance contract was concluded, to three years later, and for each year, the upper row indicates an amount or a rank set for each item. Furthermore, the lower row indicates a coefficient of the insurance premium rate depending on the rank of the item. That is, in the present embodiment, although an increase or decrease of the insurance premium according to its rank is set for the respective contracted party information, “the coefficient of insurance premium rate” is a value expressing the rate of that increase or decrease. For example, if the insurance premium is increased by 20%, then the coefficient of insurance premium rate is 1.2, and if the insurance premium is decreased by 10% then the coefficient of insurance premium rate is 0.9.

Next, the individual information that is utilized as the contracted party information, and the increase and decrease of the insurance premium rate in accordance with that content, are described with reference to FIG. 4.

For the “yearly sales” of the contracted party information, the yearly sales of the insured product is input to the computer system A2 and is recorded to the contracted party information memory portion 21 via the input output processing portion 23. It should be noted that although in the example of FIG. 4, the yearly sales is shown in units of millions of yen, it is not limited to this.

In the example of FIG. 4, the “trust rank” of the contracted party information is set to be one of a rank of four levels, “1”, “2”, “−1” and “−2” depending on whether or not there has been an accident leading to an insurance claim within a past, predetermined time period. This is recorded in the contracted party information memory portion 21. For example, if there has been an accident leading to an insurance claim within the past three years, “2” is recorded as the trust rank. In the present embodiment, if the trust rank is “2”, then the insurance premium is increased by 20%. Furthermore, if there has been no insurance claim within the past three years, the trust rank is set to “−1” and the insurance premium is reduced by 10%. Moreover, if there has been no insurance claim within the past six years, the trust rank is set to “−2”, and the insurance premium is reduced by 20%. In cases other than these, the trust rank is set to “1”, and there is no increase or decrease in the insurance premium. It should be noted that in the example in FIG. 4, the trust rank is set to four levels of “1”, “2”, “−1” and “−2”, but it is possible to set the trust rank to any number of levels, or set the insurance premium to increase or decrease at any rate in accordance with the ranking.

The “rank of the country of sale” in the contracted party information is a rank that depends on the country in which the insured party is selling the product. In the present embodiment, the ranking of the country of sale is set to a three level rank, “1”, “2” and “3”, and is stored in the contracted party information memory portion 21. If the sales in Europe, North America and Japan do not exceed 50% of the total sales of the insured party, then “2” is recorded as the rank of the country of sale. In the present embodiment, if the rank of the country of sale is “2”, then the insurance premium is reduced by 10%. Furthermore, if the sales in Europe, North America and Japan do not exceed 20% of the total sales of the insured party, then the rank of the country of sale is set to “3” and the insurance premium is reduced by 20%. In all other cases, the rank of the country of sale is set to “1”, and there is no increase or decrease of the insurance premium. It should be noted that in the present embodiment, the rank of the country of sale is set to three levels, “1”, “2” and “3”, but it is possible to set the trust rank to any number of levels, or set the insurance premium in to increase or decrease at any rate accordance with the ranking.

The “maximum compensation amount” in the contracted party information is the maximum insured amount, and represents up to how many multiples of yearly sales are compensated. In the present embodiment, the initial value of the maximum compensation amount is “1”, that is, compensation can be up to a multiple of one times the yearly sales. It should be noted that, if the insured party desires to set the maximum compensation amount to a multiple of n times the yearly sales amount, and if the insurer accepts this, then the insurance premium is calculated as the premium for compensating an amount equal to the yearly sales amount, raised to the power of n. In the present embodiment, the insurance premium is set depending on the ratio of maximum compensation amount to yearly sales amount, however it is not limited to this. For example, it is also possible to set it such that the rate of increase of the insurance premium increases with increasing value of n.

The “product risk” in the contracted party information is a rank that is determined depending on the product of the insured party. In the present embodiment, a two level ranking relating to the product is set, “1” and “2”, and recorded in the contracted party information memory portion 21. If the sales of electrical device products is 50% or more of the total product sales of the insured party, then “2” is recorded as the product risk ranking and the insurance premium is increased by 20%. In the other case, the product risk ranking is set to “1”, and there is no increase or decrease of the insurance premium. It should be noted that the number of rankings of the product risk, and the ratio of increase or decrease of the insurance premium in response to the rankings is not limited to this example, and may be set freely.

The “number of substance groups to be insured” in the contracted party information is set depending on the number of substance groups taken to be the object of the insurance. In the present embodiment, a four level ranking related to the number of substance groups that are the object of the insurance is set, “1”, “2”, “3” and “4” and recorded in the contracted party information memory portion 21. For example, if all of the 28 substance groups of JEITA: Japan Electronics Information Technology Industries Association, are taken as substances appropriate to be insured, then “1” is stored as the number of substance groups to be insured, and there is no increase or decrease in the insurance premium.

Furthermore, if 10 to 27 of the 28 JEITA substance groups are taken as substances to be insured, then the ranking of the number of substance groups to be insured is set to “2”, and the insurance premium is reduced by 3%. If 7 to 9 of the 28 JEITA substance groups are taken as substances appropriate to be insured, then the ranking of the number of substance groups to be insured is set to “3” and the insurance premium is reduced by 5%. Furthermore, if the substances appropriate to be insured are only the six RoHS substances (lead, mercury, cadmium, chromium VI polybrominated biphenyl and polybrominated diphenyl ether), then the ranking of the number of substance groups to be insured is set to “4”, and the insurance premium is reduced by 7%. It should be noted that the number of rankings dependent on the number of substances (substance groups) to be insured, and the ratio of increase and decrease of the premium depending on the rankings is not limited to this example, and can be set freely.

The “substance risk level” in the contracted party information is a ranking that the insurer sets depending on the level of legal regulations on the designated environmentally hazardous substance, and its ratio. In some cases, it is possible to link it to the level of legal regulation in the country in which it is sold. In the present embodiment, a two level rank is set as the substance risk level, “1” and “2”, and this is recorded in the contracted party information memory portion 21. If all six of the RoHS substances are included in the designated environmentally hazardous substances, then a substance risk level of “1” is recorded, and there is no reduction in the insurance premium. If the substances included in the designated environmentally hazardous substances are three or less of the six RoHS substances, then the substance risk level is set to “2”, and the premium is reduced by 10%.

The “contracted party analysis frequency” in the contracted party information is set in accordance with the frequency at which the insured party itself analyses the product. In the present embodiment, the rank of the contracted party analysis frequency is set to three levels, “1”, “2” and “3”, and is recorded in the contracted party information memory portion 21. For example, if analysis is performed on every product lot, then “1” is recorded as the contracted party analysis frequency, and there is no increase or decrease in the insurance premium. Furthermore, if the analysis is carried out regularly at once per month, then the ranking of the contracted party analysis frequency is set to “2”, and there is a 10% increase in the insurance premium. Furthermore, if the analysis is carried out regularly, but the frequency is less than once per month (for example, once every two months), then the ranking of the contracted party analysis frequency is set to “3” and the insurance premium is increased by 20%. It should be noted that the number of ranks of the contracted party analysis frequency is not limited to this example. Furthermore, the correspondence of the period of regular analysis and the ranking, and the ratio of increase or decrease of the insurance premium in accordance with the rankings is not limited to this example, and may be freely set. Furthermore, as a “contracted party environmental approach level”, this information may be substituted by acquiring ISO 14001, or a specific environmental qualification, for example a simple qualification such as the Kyoto environmental management system (KES), by acquiring the supply partner qualification of a specified manufacturer, and it is possible to input information of both the “contracted party analysis frequency” and the “contracted party environmental approach level”.

The “analysis option” of the contracted party information is a ranking that is set in accordance with the frequency at which the analysis of the insured product is commissioned to the analytical company (NN Analytical Company) by the insurer (AAA Insurance Company). In the present embodiment, the analysis option is set to a 4 level ranking, “0”, “1”, “2” and “3”, and is recorded in the contracted party information memory portion 21. For example, if regular commissioning of analysis to the designated analytical company of the insurer is not carried out at all, then “0” is recorded as the analysis option and there is no decrease of the insurance premium. If analysis is commissioned to the NN Analytical Company with every product lot, then the analysis option is set to “1”, and the insurance premium is reduced by 50%. Furthermore, if analysis is requested regularly at once per month, the analysis option is set to “2” and the insurance premium is reduced by 20%. Furthermore, if analysis is regularly requested, but the frequency is less than once per month (for example once every two months), then the analysis option is set to “3”, and the insurance premium is reduced by 10%. It should be noted that the number of levels in the ranking of the analysis option is not limited to this example. Furthermore, the correspondence of the period of the regular analysis to the ranking, and the rate of increase or decrease of the insurance premium in accordance with the rankings are not limited to this example, and can be set freely.

The “analysis variability” risk in the contracted party information is a ranking that is set in accordance with the variability in the results from the contracted party themselves, or from the NN Analytical Company. That is to say, in the case of analysis by the contracted party themselves, and in the case of analysis by the analytical company, in the insurance system according to the present embodiment analysis is performed on a plurality of lots of the same product. Thus, variability in the data of the analysis results of the plurality of lots is determined, and the analysis variability risk is set in accordance with the amount of variation. As noted above, this is because it seems that as the analysis variability increases and the upper concentration limit is approached, there is an increase in the probability that a dangerous substance will cause unintentional contamination.

In the present embodiment, the analysis variability risk is set to a four level rank of “1”, “2”, “3” and “4”, and is recorded in the contracted party memory portion 21. For example, if the probability that the upper concentration limit is exceeded due to variability of the data of the analysis result is 1 ppb or less, then “1” is recorded as the ranking of the analysis variability risk, and the insurance premium is reduced by 80%. If the probability that the upper concentration limit is exceeded due to variability of the data of the results of the analysis is 100 ppb or less, then the ranking of the analysis variability risk is set to “2”, and the insurance premium is reduced by 5%. Furthermore, if the probability that the upper concentration limit is exceeded due to variability of the data of the analysis result is 1 ppm or less, then the ranking of the analysis variability risk is set to “3” and there is no increase or decrease of the insurance premium. On the other hand, if the probability that the upper concentration limit is exceeded due to variability of the data of the analysis result exceeds 100 ppm, then the ranking of the analysis variability risk is set to “4”, and the insurance premium is increased by 10%. However, the number of ranks of the analysis variability risk is not limited to this example. Furthermore, the correspondence of the period of the variability in the analysis results to the ranking, and the rate of increase or decrease of the insurance premium in accordance with the rankings are not limited to this example, and can be set freely. The upper concentration limit mentioned here is the allowable concentration of the substances that the insurer sets, based on the legal restrictions of the applicable countries. It may also be the value of allowable content of a representative insured party.

The following is a more specific description of how to calculate the insurance premium using the contracted party information as noted above.

First the insurance premium of the first year after concluding the insurance contract is described. In the example of FIG. 4, for the XX Electrical Parts Corporation, which is the insured party, the yearly sales amount of the product to be insured is approximately 3 billion yen. The trust ranking is set at “1” in the first year. The rank of the country of sale is “1”, since there is no designation from the insured party, and the maximum compensation amount is set to the same amount as the yearly sales of the insured product (rank of the maximum compensation amount is “1”), being 3 billion yen. Furthermore, since the sales amount of electrical devices is less than 50% of the total sales amount of the XX Electrical Parts Corporation, the ranking of the product risk is “1”. Moreover, in this case the object of the insurance is taken to be the 28 JEITA substance groups and thus ranking of the number of insured substance groups is “1”. Furthermore, the substance risk level is “1”. Also, since the XX Electrical Parts Corporation performs analysis on every lot by themselves, the ranking of the contracted party analysis frequency is “1”. Furthermore, since the insurer has not included regular analysis (the analysis option) by a designated analytical company in the first year of the policy, the ranking of the analysis option is “0”. Moreover, since the variability of the analysis by the XX Electrical Parts Corporation is greater than 1 ppb and is 100 ppb or less, the analysis variability risk is “2”. Furthermore, the standard insurance premium rate is taken to be 0.01 times the maximum compensation amount.

Thus, in the example of FIG. 4, since the ranking of the analysis variability risk is “2”, the insurance premium rate is reduced by 5%. Consequently, the coefficient of insurance premium rate relating to analysis variability risk is 0.95 as shown on the lower line of the analysis variability risk at the “time of insurance contract establishment” of FIG. 4. It should be noted that the coefficients of insurance premium rate corresponding to the rankings of the contracted party information are stored in advance in the computer system A2 of the AAA Insurance Company (for example it may also be in the contracted party information memory portion 21).

The CPU 22 in the computer system A2 of the AAA Insurance Company calculates the yearly insurance premium that the insured party should pay by multiplying the standard insurance premium rate by the coefficients in accordance with the rankings of the contracted party information. For example, in the example of FIG. 4, the annual insurance premium of the XX Electrical Parts Corporation is 3 billion yen×0.01×0.95=28.5 million yen.

Next, in the year after concluding the insurance contract, assuming that there have been no accidents to claim an insured amount in the one year period from concluding the insurance contract, the trust rank of XX Electrical Parts Corporation is changed to a setting of “−1” as shown in the “after one year” line of FIG. 4. In this case, as noted above, the insurance premium is reduced by 10% and thus the coefficient of insurance premium rate relating to trust rank is 0.9 as shown in the line beneath it. Furthermore, in this year, since the XX Electrical Parts Corporation accepts that NN Analytical Company analyzes every product lot, its ranking of analysis option is changed from “0” to “1”. As previously explained, if the ranking of the analysis option is “1”, then the insurance premium is reduced by 50%, and thus the coefficient of insurance premium rate relating to the analysis option is set to 0.5. Moreover, since there was less variability in the analysis results, the ranking of the analysis variability risk is changed from “2” to “1”. If the ranking of the analysis variability risk is “1”, then the insurance premium is reduced by 80%, and thus the coefficient of insurance premium rate relating to analysis variability risk is 0.2. From the foregoing information, the CPU 22 calculates the yearly insurance premium for the year after concluding the insurance contract to be 3 billion yen×0.01×0.9×0.5×0.2=2.70 million yen.

Next, in the second year after concluding the insurance contract, since there have been no accidents to claim an insured amount in the two year period, the trust rank is changed to “−2”. If the trust rank is “−2”, then the insurance premium is reduced by 20%, and thus the coefficient of the insurance premium rate relating to trust rank is 0.8 as shown in the lower line of the trust rank of FIG. 4. Furthermore, this year the XX Electrical Parts Corporation has removed the analysis option (it stopped accepting analysis of every product lot by the NN Analytical Company), and thus the ranking of the analysis option is changed from “1” to “0”. Thus, the coefficient of the insurance premium rate relating to the analysis option is 1. Furthermore, the ranking of the analysis variability risk is the same as the previous year, at “1”. From the foregoing information the CPU 22 calculates the yearly insurance premium for the year period two years after concluding the insurance contract to be 3 billion yen×0.01×0.8×0.2=4.80 million yen.

Moreover, three years after concluding the insurance contract, as shown in the “after three years” line of FIG. 4, an action is taken whereby the insurer (AAA Insurance Company) increases the yearly insurance premium rate from 0.01 to 0.015, for reasons such as an increase in insurance payouts across the entire society of 1.5 times over the previous year. Furthermore, for the XX Electrical Parts Corporation, there has been no claim for an insurance amount over the past three years, and so the contracted party information is the same as the previous year. In this case, the CPU 22 calculates the yearly insurance premium for this year to be 3 billion yen×0.015×0.8×0.2=7.20 million yen.

As noted above, in the insurance system according to the present embodiment, the CPU 22 in the computer system A2 of the AAA Insurance Company calculates the yearly insurance premium rate based on the contracted party information recorded in the contracted party information memory portion 21.

It should be noted that if there is a change in the contracted party information, then it is preferable that the insured party contacts the insurer, and that the changes are reflected in the insurance premium. In particular, if there is a difference with the pre-renewal value that is equal to or greater than a standard difference as a result of an update of information such as product risk information, manufacturing country information, sales country information, the number of types of environmentally hazardous substances that are to be insured against and the risk of the environmentally hazardous substances that is to be insured, from among the contracted party information, then because there is the possibility of a large fluctuation in the compensatory loss risk of the insurer, it is preferable to recalculate the insurance premium based on the updated contracted party information.

Furthermore, the contracted party information is not limited to information provided by the insured party, and it is possible to use information that the insurer has collected themselves (for example, information such as trust information on the insured party) as the contracted party information. Moreover, as an alternative to information about the insured party, it is also possible to alter the insurance premium rate in accordance with the general social situation. For example, in the example of FIG. 4, three years after concluding the insurance contract, the standard insurance premium rate was changed from 0.01 to 0.015 due to a change in the situation of the society.

Furthermore, it is also possible that in addition to the input of contracted party information, the insurer requests certification or a declaration that the insured party is not using designated environmental related substances in the manufacturing process. If such certification or declaration does not exist, then because the compensatory loss risk increases, thus it is possible to set the insurance premium rate to higher than the standard (for example, a multiple of 2 times that of the case in which there is a declaration).

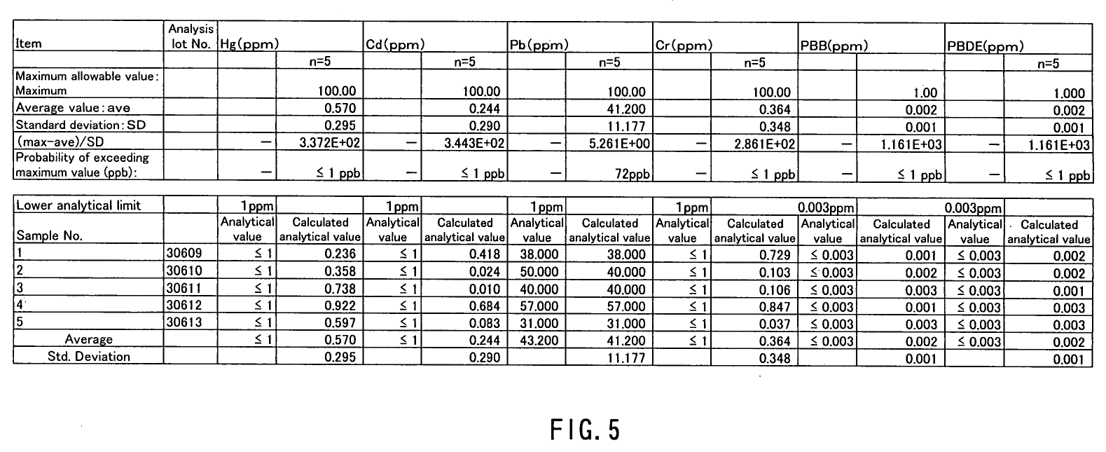

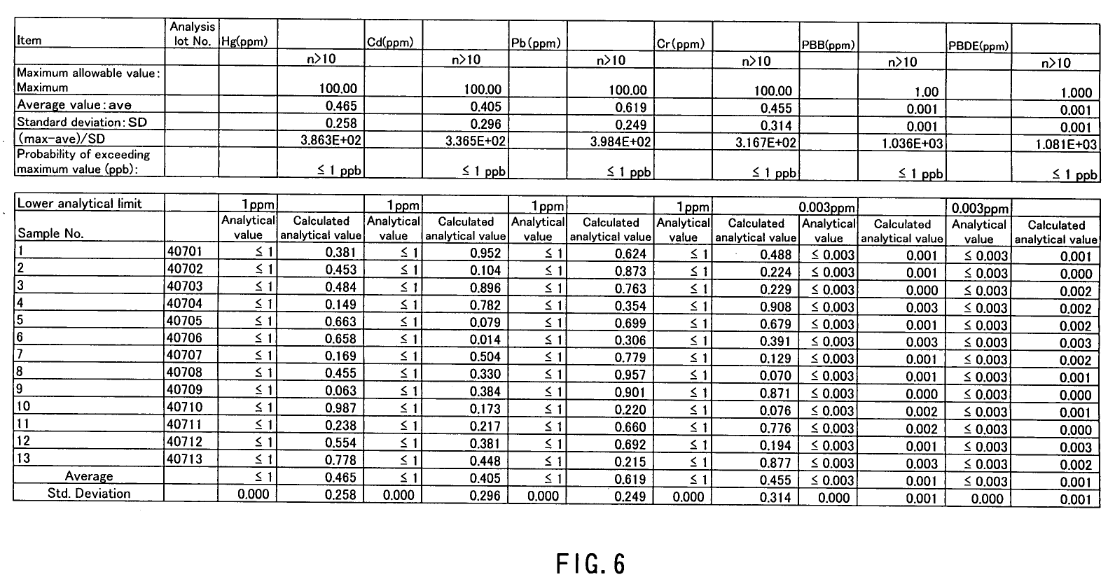

An example of the results of analysis at the time of concluding the insurance contract is shown in FIG. 5, and an example of the results of analysis after a certain period of time has passed after concluding the insurance contract is shown in FIG. 6. In this example, the insured party (manufacturer), after concluding the insurance contract, has made changes such as changing the solder conventionally used in the product to lead free solder in order to tighten the management of environmentally hazardous substances. As can be seen by comparing FIG. 5 and FIG. 6, after concluding the insurance contract, all the values in the results of analysis are at or below the analysis limits. If the results of analysis in FIG. 5 are less than or equal to the lower analytical limit, then in a case in which it is not possible to calculate the probability by statistical treatment, by setting random numbers between zero and the lower analytical limit it is possible to calculate the probability if these are taken as a standard deviation and a normal distribution, and thus this method of treatment is preferred. Furthermore, if the amount of included chromium is small, then, as shown in FIG. 5, by analyzing and managing the chromium VI as if it were the total amount of chromium, and analyzing for chromium VI only if the total is large, management is facilitated and is preferable. If the number of analyses n is not more than 10, then it is preferable to calculate an estimate of the SD (standard deviation) by considering a calculation from the range, (maximum data−minimum data)×(calculation coefficient according to the number n). The calculation coefficients are n=2 (0.8862), n=3 (0.5918), n=4 (0.4857), n=5 (0.4299), n=6 (0.3946), n=7 (0.3698), n=8 (0.3512), n=9 (0.3367) and n=10 (0.3249).

If the analyzed values are equal to or less than the lower analytical limit, then the analysis values may be either treated with random values that do not exceed the lower analytical limit, or the SD (standard deviation) set to a value that is the lower limit value multiplied by a constant. In FIG. 5, in the cases where the analyzed values are equal to or less than the lower analytical limit, i.e., the samples Nos. 1 to 5 for Hg, the samples Nos. 1 to 5 for Cd, the samples Nos. 1 to 5 for Cr, the samples Nos. 1 to 5 for PBB, and the samples Nos. 1 to 5 for PBDE, SD is set to the lower analytical limit.

Furthermore, when FIG. 5 and FIG. 6 are compared, since the standard deviation of FIG. 6 is small (that is to say, the variability is small) and the value is small, it can be seen that the probability of it exceeding the maximum value (upper limit value) is small. That is to say, it can be seen that FIG. 6 has a small analysis variability risk.

In the present embodiment, the insuring company may change the maximum allowable value, with consideration to societal changes. The societal changes (such as information on new regulations) are made known to the insured party, and if changes are made to the maximum value, then these are also made known to the insured party.

Thus, in the insurance system according to the present embodiment, there is the advantage that the compensation loss risk for the insurer is clearly reduced. Furthermore, since the insurance premium is calculated in accordance with the results of the analysis of the insured product, it has the advantage in that, for the insured party, the next calculated insurance premium (for example, the following year) can be reduced by the company making efforts to find substitutes for environmentally hazardous substances and to prevent contamination.

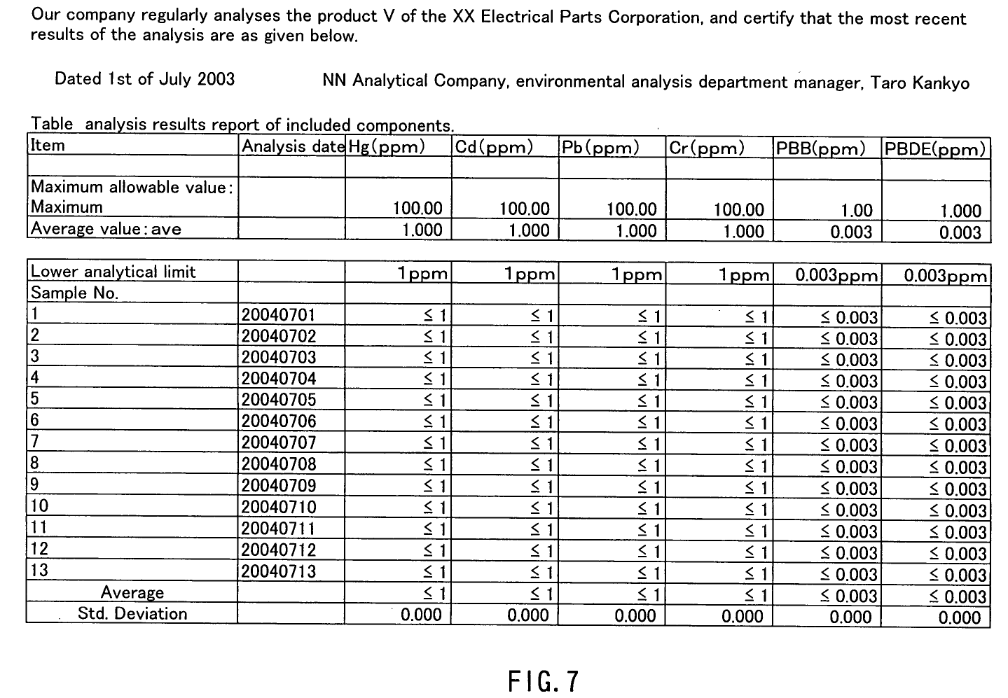

FIG. 7 shows an example of an analysis result certificate based on an example of analysis results after a certain period of time has passed after concluding the insurance contract. This analysis results certificate is a document that the analytical company provides to the insurer.

The results of analysis by the third party is also submitted to the insured party that is a manufacturer or a vendor of a product, if desired, as described above. The manufacturer or the vendor of the product submits the certificate of the results of analysis together with one of the insurance certificates A and B to the customer, whereby a predominant business method capable of further obtaining the reliability from a customer can be established.

It should be noted that in the present embodiment, an example is given in which data is exchanged between the computer system X1 of the XX Electrical Parts Corporation and the computer system A2 of the AAA Insurance Company via the network 5, however means for inputting contracted party information into the computer system A2 of the AAA Insurance Company is not limited to such an online process. For example, information transmitted from the XX Electrical Parts Corporation by document or electronic medium (such as a magnetic disk or an optical disk, for example) may be input into the computer system A2 by an operator of the AAA Insurance Company.

Furthermore, in the present embodiment, an example is described in which the present invention is embodied principally by a computer system, however the present invention may also be embodied by a computer program product. For example, a program product in which a program that includes commands for letting a computer execute the procedure of the processes executed by the CPU 22 in the present embodiment is recorded on a recording medium. Furthermore, for the system of the present invention, if the approach of the insured party toward environmentally hazardous substances is at a high level, then simply by continually decreasing the probability of accidents involving the environmental related substances, the insurance premium becomes cheaper. Thus, the level at which the insured parties approach environmental related substances increases, and it may be expected that the overall level of the world community's approach toward environmentally hazardous substances will increase.

As described above, in order to realize environmentally hazardous substance insurance to insure against accidents involving environmentally hazardous substances, the present invention is effective as a computer system and computer program product for calculating the appropriate premium that the insured party should pay to the insurer.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes that come within the meaning and range of equivalency of the claims are intended to be embraced therein.

1. An environmentally hazardous substance insurance system for calculating an insurance premium of an environmentally hazardous substance insurance to compensate for damages if an environmentally hazardous substance that is to be insured is unintentionally included in a product of an insured party, the environmentally hazardous substance insurance system comprising:
an input portion for inputting at least information specifying the environmentally hazardous substance that is to be insured and information relating to a result of analysis of the product of the insured party, as contracted party information relating to the insured party;
a contracted party information memory portion for at least temporarily recording the contracted party information; and
an insurance premium calculation portion to calculate the insurance premium based on the contracted party information stored in the contracted party information memory portion.

2. The environmentally hazardous substance insurance system according to claim 1,
wherein information relating to variability of results of analysis of the environmentally hazardous substance carried out on a plurality of lots of the insured product, as information relating to the results of analysis of the product of the contracted party is input by the input portion.

3. The environmentally hazardous substance insurance system according to claim 1,
wherein at least one selected from information on trust of the insured party, product sales information, manufacturing country information, sales country information, maximum compensation amount, product risk information, number of types of environmentally hazardous substance that are insured against, degree of risk of the environmentally hazardous substance taken as the object of the insurance and frequency of analysis of the insured product are further input by the input portion, as contracted party information.

4. The environmentally hazardous substance insurance system according to claim 3,
wherein if there is a difference with a pre-renewal value that is equal to or greater than a standard difference as a result of a renewal of information included in the contracted party information, from among product risk information, manufacturing country information, sales country information, the number of types of environmentally hazardous substance that are to be insured against and the degree of risk of the environmentally hazardous substance that is to be insured, then an insurance premium calculation portion recalculates the insurance premium based on the contracted party information after it is renewed.

5. The environmentally hazardous substance insurance system according to claim 1,
wherein information relating to whether a party other than the insured party performs analysis relating to environmental related substances of the product that is to be insured are further input by the input portion, as contracted party information.

6. A computer program product in which a computer program to calculate an insurance premium of an environmentally hazardous substance insurance to compensate damages if an environmentally hazardous substance is included, by an accident, in a product that is to be insured of an insured party, is recorded on a recording medium, the computer program including commands to cause a computer to execute:
a process of inputting at least information specifying an environmental related substance to be insured and information relating to results of analysis of a product of the contracted party, as contracted party information relating to the insured party;
a process of at least temporarily recording the contracted party information, to a contracted party information memory portion, and
a process of calculating the insurance premium based on the contracted party information recorded in the contracted party information memory portion.

7. The computer program product according to claim 6, wherein
information relating to variability of the results of analysis of the environmentally hazardous substance, carried out on a plurality of lots of the product that is to be insured is further input as information relating to the results of analysis of the product of the contracted party.

8. The computer program product according to claim 6,
wherein at least one selected from information on trust of the insured party, product sales information, manufacturing country information, sales country information, maximum compensation amount, product risk information, number of types of environmentally hazardous substance that are insured against, degree of risk of the environmentally hazardous substance taken as the object of the insurance and frequency of analysis of the insured product, are further input as the contracted party information.

9. The computer program product according to claim 8,
wherein if there is a difference with a pre-renewal value that is equal to or greater than a standard difference as a result of a renewal of information included in the contracted party information, from among product risk information, manufacturing country information, sales country information, the number of types of environmentally hazardous substance that are to be insured against and the degree of risk of the environmentally hazardous substance that is to be insured, then the insurance premium calculation portion recalculates the insurance premium based on the contracted party information after the renewal.

10. The computer program product according to claim 6,
wherein information relating to whether a party other than the insured party performs analysis relating to environmental related substances of the product is further input as contracted party information.

11. A business method of a product, wherein, in a sale of the product, a vendor or a manufacturer submits, to a purchaser of the product, a certificate of results of analysis by a third party of at least a plurality of environmentally hazardous substances of a plurality of lots, and at least one of an insurance certificate for insuring that the product does not include at least the plurality of environmentally hazardous substances in terms of design, and an insurance certificate for compensating for a damage in a case where an environmentally hazardous substance is included in the product due to an accident.
